(19) United States
(12) Patent Application Publication
(10) Pub. No.: US 2006/0099137 A1
(43) Pub. Date: May 11, 2006

(54) Fluorine production systems and methods

(76) Inventors: Valery Georgiyevich Barabanov, St. Petersburg (RU); Andrey Sergeyevich Kuznetsov, St. Petersburg (RU); Victor Alexeyevich Lvov, Angarsk (RU); Vladimir Sergeyevich Menshov, Angarsk (RU); Yury Alexeyevich Petrov, St. Petersburgh (RU); Rostislav Leonidovich Rabinovich, Angarsk (RU); Mikhail Vasilyevich Sapozhnikov, Moscow (RU); Victor Panteleymonovich Shopen, Angarsk (RU)

Correspondence Address: WELLS ST. JOHN P.S., 601 W. FIRST AVENUE, SUITE 1300, SPOKANE, WA, 99201, US

(21) Appl. No.: 11/152,397

(22) Filed: Jun. 13, 2005

Related U.S. Application Data
(63) Continuation-in-part of application No. PCT/RU03/00359, filed on Aug. 8, 2003.

(51) Int. Cl. C01B 9/08

(52) U.S. Cl. 423/464

(57) ABSTRACT

Fluorine generation systems are provided that can include, in exemplary embodiments, a reactor configured to decompose a fluorine-comprising material. The reactor can include a plurality of chambers with at least one of the chambers being configured to receive the fluorine-comprising material. The chamber includes sidewalls with the exterior of the sidewalls being at least partially encompassed by heating elements. The system can also include a fluorine reservoir coupled to the reactor with the reservoir configured to receive fluorine upon the decomposition of the fluorine-comprising materials. Fluorine-generation processes are provided that can include, in exemplary embodiments, decomposing pellets of a fluorine-comprising material with the pellets having an average size of from about 1.0 mm to about 3.0 mm. Processes can also include decomposing a composition comprising manganese-fluoride.

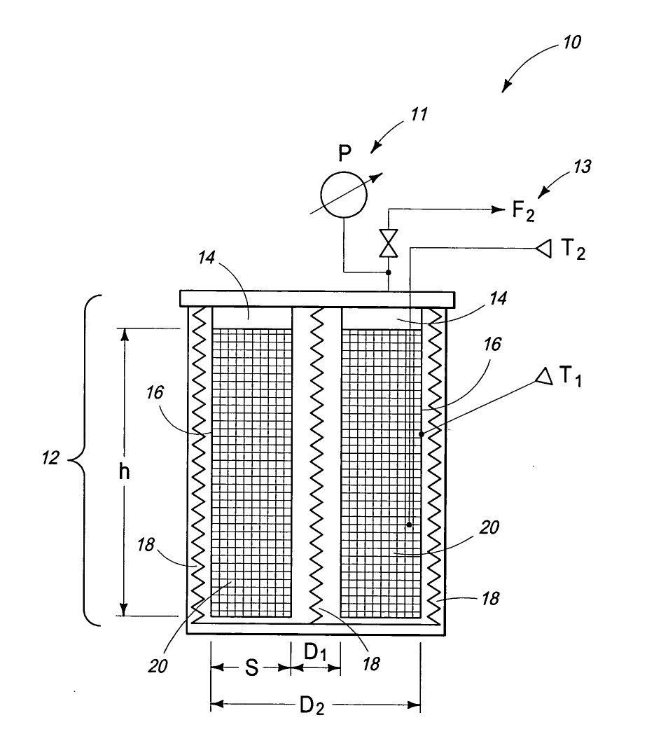

### CROSS REFERENCE TO RELATED APPLICATION

This application is a Continuation-in-Part of and claims priority under 35 U.S.C. §120 to International Patent Application Serial No. PCT/RU2003/000359, filed on Aug. 8, 2003, the entirety of which is incorporated by reference herein.

### TECHNICAL FIELD

This disclosure relates to chemical production systems and methods and more particularly to fluorine production systems and methods. Exemplary embodiments relate to the field of fluorine production, specifically methods for producing fluorine from solid metal fluorides or their complex salts by thermal decomposition.

### BACKGROUND OF THE INVENTION

Gaseous fluorine is used in many fields, like production of fluorine compounds by direct fluorination, in metal welding, to form protective films on metals or in the treatment of metal and alloy surfaces, etc., and also as an etching reagent in microelectronics.

The systems and methods described herein can be used in many areas, including those described above, where the use of fluorine in pure and other forms is required.

Fluorine and other fluorine-comprising gaseous compounds, like NF₃ or fluorine, are usually stored in gaseous form in cylinders under high pressure or in the form of cryogenic liquids at low temperatures.

Storage of fluorine or fluorine-comprising gaseous compounds in gaseous form requires volumes that are tens of times greater than storage of liquids.

It can be beneficial to have a possibility for simple and safe production of fluorine in the necessary volume and at the required location, from compounds whose transport does not pose special problems. Similarly, storage of fluorine or fluorine-comprising material at ambient temperatures and pressures, incorporated in a solid matrix, or bonded in some other solid form, can have an advantage in terms of safety and storage efficiency.

A pure fluorine generator is known (U.S. Pat. No. 4,711,680, published Dec. 8, 1987), in which fluorine is produced from a granulated solid composition that can be comprised of a thermodynamically unstable fluoride of a transition metal and a stable anion. Fluorine is formed as a result of a substitution reaction of a strong Lewis acid, accompanied by rapid irreversible decomposition of the unstable transition metal fluoride to a stable lower fluoride and elemental fluorine at high pressure. The fluorine generator with solid granules can include a stable salt containing an anion, originating from the thermodynamically unstable transition metal fluoride with a high degree of oxidation, and a Lewis acid, which is stronger than this transition metal fluoride. This acid is a solid at ambient temperature, but melts or sublimes at elevated temperature. The cation of this stable salt contains an anion originating from a thermodynamically unstable transition metal fluoride with a high degree of oxidation, chosen from the group consisting of alkali or alkaline earth metals. The reaction is described to occur as follows:
A₂MF₆+2Y→2AYF+[MF₄].

Since the free metal fluoride MF₄ can be thermodynamically unstable, it can spontaneously decompose to MF₂ and F₂ according to an irreversible reaction that permits generation of fluorine under high pressure without secondary reactions:
[MF₄]→MF₂+F₂.

The following compositions have been described to generate fluorine in combination with the Lewis acid: A₂MF₆, K₂NiF₆, K₂CuF₆, Cs₂CuF₆, Cs₂MnF₆, K₂NiF₆, BiF₅, BiF₄, and TiF₄.

Another method for producing and storing pure fluorine is known (U.S. Pat. No. 3,989,808, published Nov. 2, 1976). The method uses fluorides of alkali metals and nickel, which adsorb fluorine to form complex nickel salts. After filling the generator with solid, the gaseous impurities are pumped out. The complex nickel fluoride is then heated and gaseous fluorine with a high degree of purity is released. However, the method does not permit fluorine production with a constant rate of gas generation.

The task facing the developers of the invention was to devise a method for producing gaseous fluorine with extraction from metal fluorides with a high degree of oxidation, with the possibility of producing fluorine gas at constant pressure. The method can be simple and safe to use. The degree of fluorine extraction can be no less than 99%.

### SUMMARY OF THE INVENTION

Fluorine generation systems are provided that can include, in exemplary embodiments, a reactor configured to decompose a fluorine-comprising material. The reactor can include a plurality of chambers with at least one of the chambers being configured to receive the fluorine-comprising material. The chamber includes sidewalls with the exterior of the sidewalls being at least partially encompassed by heating elements. The system can also include a fluorine reservoir coupled to the reactor with the reservoir configured to receive fluorine upon the decomposition of the fluorine-comprising materials.

Fluorine-generation processes are provided that can include, in exemplary embodiments, decomposing pellets of a fluorine-comprising material with the pellets having an average size of from about 1.0 mm to about 3.0 mm. Processes can also include decomposing a composition comprising manganese-fluoride.

### DESCRIPTION THE FIGURE

The FIGURE is an exemplary system according to an embodiment.

### DETAILED DESCRIPTION

This disclosure of the invention is submitted in furtherance of the constitutional purposes of the U.S. Patent Laws “to promote the progress of science and useful arts” (Article 1, Section 8).

Systems and methods for fluorine production are provided than can include heating fluorine-comprising materials, such as solid binary or complex metal fluorides, with a high degree of oxidation to a temperature below the melting point of the fluorine-comprising material and/or to a temperature of 150-400° C. The fluorine-comprising materials can be in granulated or pelletized form, such as granules and/or pellets having a size from about 1.0 to about 3.0 mm. In exemplary embodiments, the fluorine-comprising material can take the form of a bed within a reactor and a temperature drop in the bed can be less than about 15° C.

Fluorine-comprising materials can include manganese salts with a high fluorine content, potassium salts (hexafluoronickelate) K₂NiF₆, manganese tetrafluoride MnF₄ and salts, such as, K₃NiF₇ and K₂CuF₆, for example. Fluorine-comprising materials can include metal-fluorides, the fluorine of the fluorine-comprising material can be in ionic form, such as a salt, but it can also take the form of organic fluorine covalently bonded to a structure or within a matrix. The fluorine-comprising material can include material comprising compositions having the general formula A₂MF₆, with M being a transition metal and A an alkali metal. M can be one or more of Mn, Fe, Co, Ni, and Cu, and A can be one or more of K and Cs, for example. Fluorine-comprising material also includes K₂NiF₆, K₂CuF₆, CS₂CuF₆, Cs₂MnF₆, BiF₅, BiF₄, TiF₄, MnF₄, and K₃NiF₇, and/or materials that include Li, Cs, Mg, Ba, K, Bi, and Ti, in exemplary embodiments. Fluorine-comprising materials can also include manganese-fluoride.

The fluorine-comprising material can be pelletized with the pellets having a size that, in exemplary embodiments, provides a certain free space between the pellets when packed in a bed, that can allow for optimal heating and withdrawal of the generated gaseous fluorine. The pellet size should be in the range of 1.0-3.0 mm, and this is achieved by screening the starting compounds on sieves with a specified hole dimension.

The fluorine-comprising materials can be provided to a reactor and once within the reactor the materials can be comprised by a bed of the materials. Decomposing the materials to recover fluorine can include heating the bed with the heating being relatively uniform throughout the bed, for example. The heating of the materials can be performed in the absence of a Lewis Acid catalyst. According to an embodiment, the uniform heating can include maintaining a temperature drop in the bed of material to a range of less than about 15° C. Uniform heating can provide controllable fluorine generation and the smaller the temperature drop, the more favorable the gas production can be. It can be difficult with known methods to accomplish instantaneous and/or uniform heating of the bed without substantial temperature differences throughout the material. Exemplary embodiments of the disclosure provide systems and methods that can achieve instantaneous and/or uniform heating of the bed, both by reducing the thickness of the bed and by selection of the heat supply method, for example.

An exemplary system 10 for use according to methods described herein is depicted in the FIGURE. System 10 includes a reactor 12 coupled to a fluorine reservoir 13. Reactor 12 and reservoir 13 can also have a regulator 11 therebetween.

Reactor 12 can be a cylindrical vessel and, in exemplary embodiments, can include chambers 14. Chambers 14 can have sidewalls 16 and the sidewalls can be encompassed or at least partially encompassed by heating elements 18. Chambers 14 and/or materials of system 10 coming in contact with the fluorine-comprising material and/or the products generated during the decomposition of the material can include materials resistant to the effect of fluorine under the given conditions, for example, nickel or special alloys.

Reactor 12 can be configured to provide uniform heating to a bed 20 of fluorine-comprising material. In exemplary embodiments, reactor 12 and/or chambers 14 of reactor 12 can have: a height (h) of about 500 mm, a diameter (D₁) between chambers of 20 mm, an overall diameter (D₂) of about 90 mm with the width (S) of chambers 14 configured to receive the bed being about 35 mm. System 10 can include thermocouples and monitoring equipment (not shown) configured to regulate and/or monitor the temperature of bed 20. Heating elements 18 can be configured outside chambers 14 and/or within chambers 14. Devices for temperature measurement, such as thermocouples, (T₁ and T₂) and pressure measurement (P) can also be provided to facilitate uniform heating and the recovery of fluorine within reservoir 13.

Reservoir 13 coupled to reactor 12 can be configured to receive and/or remove fluorine generated upon decomposition of the fluorine-comprising material within chambers 14. Chambers 14 are configured to receive a bed 16 of the fluorine-comprising material. During heating, generation of pure fluorine occurs, which is taken off from the generating device and sent to use.

The FIGURE shows a general diagram of the apparatus for conducting the method. The conditions for specific accomplishment of the method are shown by way of the following examples that are presented for purposes of describing the invention and should not be relied upon to limit the scope of the invention to which the inventors are entitled.

### EXAMPLE 1

About 3600 g of the salt K₂NiF₆ is charged to chamber 14 of system 10 in the form of granules measuring 3.0 mm (which were isolated beforehand by fractionation on sieves). Reactor 12 is closed and evacuated to a residual pressure of 0.1 mmHg, whereupon chambers 14 are heated with heaters 18 to a temperature T₁, below the melting point of the salt. Upon recording a predetermined pressure at device 11, for example about equal to 0.1 MPa, system 10 is configured to provide fluorine to reservoir 13 via opening a valve between reactor 12 and reservoir 13, for example. The temperature of bed 20 is monitored to have a difference between T₂ and T₁ of less than 15° C. (i.e., T₂<T₁=15° C.).

The process is considered completed, when the pressure P=0.1 MPa is lower than the assigned value by 25%. Heating can then be disengaged, reactor 12 cooled, the at least partially decomposed fluorine-comprising material discharged and weighed. The weight of the decomposed material (G₂) is 3160 g. The weight of the obtained fluorine is determined according to the weight difference:
G_{F}=(M_{F}_{₂} G_{T}_{₁}):M_{K}_{₂}_{NiF}_{₆}=545 g.

### EXAMPLE 2

3770 g of the salt K₂NiF₆ is charged to chamber 14 in the form of granules measuring 1.0 mm (which were first isolated by fractionation on sieves). Reactor 12 is closed and evacuated to a residual pressure of 0.1 mmHg and chambers 14 are heated to a temperature T₁ equal to 290° C. Upon reaching a predefined pressure on device 11 equal to about 0.005 MPa, a valve to reservoir 13 is opened. The temperature of bed 20 is monitored, which is measured as T₂ and amounts to 3° C., i.e., T₂=T₁−3° C. After a pressure reduction to 0.005 MPa is reached, heating is disconnected, the reactor cooled and the discharged material weighed. According to calculations, its weight was 567 g, (i.e., the degree of fluorine extraction was 99.1%).

Examples 3-7 were conducted in system 10 according to the methods described above to decompose the fluorine-comprising materials recited in Table 1 below.

TABLE 1
Examples of the method for fluorine production

| | Starting substance | | | | | | |
|---|---|---|---|---|---|---|---|
| | K₂NiF₆ | | | MnF₄ | | K₂CuF₆ | |
| | Example no. | | | | | | |
| Parameters | 1 | 2 | 3 | 4 | 5 | 6 | 7 |
| Charge, g | 3600 | 3770 | 2507 | 3300 | 3300 | 2555 | 2555 |
| Temperature, ° C. | 400 | 290 | 300 | 200 | 350 | 150 | 200 |
| Particle size | 3.0 | 1.0 | 2.0 | 2.0 | 3.0 | 1.0 | 3.0 |
| Temperature drop in bed, ° C. | 15 | 3 | 7 | 1 | 8 | 1 | 10 |
| Amount of generated fluorine, g | 545 | 565 | 545 | 565 | 564 | 525 | 524.5 |
| % generated fluorine | 99 | 99.2 | | 99.4 | 99.35 | 99.3 | 99.25 |
| Pressure of generated fluorine, MPa | 0.1 | 0.005 | 0.007 | 0.05 | 1.0 | 0.05 | 0.1 |

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A fluorine generation system comprising:
a reactor configured to decompose a fluorine-comprising material, the reactor comprising a plurality of chambers, at least one of the chambers being configured to receive the fluorine-comprising material, wherein the chamber comprises sidewalls, the exterior of the sidewalls being at least partially encompassed by heating elements; and
a fluorine reservoir coupled to the reactor, the reservoir configured to receive fluorine upon the decomposition of the fluorine-comprising materials.

2. The system of claim 1 wherein the reactor comprises nickel.

3. The system of claim 1 wherein the reactor is cylindrical.

4. The system of claim 1 wherein the fluorine-comprising material comprises a metal-fluoride.

5. The system of claim 1 wherein the fluorine-comprising material comprises ionic fluoride.

6. The system of claim 1 wherein the fluorine-comprising material comprises A₂MF₆, wherein M is a transition metal and A is an alkali metal.

7. The system of claim 6 wherein the fluorine-comprising material comprises K₂NiF₆.

8. The system of claim 1 wherein the fluorine-comprising material comprises pellets of a metal-fluoride.

9. The system of claim 8 wherein the pellets have an average size of from about 1.0 mm to about 3.0 mm.

10. The system of claim 1 wherein the chamber is configured to receive a bed of the fluorine-comprising material, the bed comprising an upper portion and a lower portion.

11. The system of claim 10 wherein the heating elements are configured to heat the upper portion to a first temperature and the lower portion to a second temperature, wherein the first and second temperatures differ by less than or equal to about 15° C.

12. The system of claim 11 wherein the first and second temperatures are both from about 150° C. to about 400° C.

13. A fluorine-generation process comprising decomposing a composition comprising manganese-fluoride.

14. The process of claim 13 wherein the composition comprises MnF₄.

15. The process of claim 14 wherein the composition is comprised by pellets, the pellets having an average size of from about 1.0 mm to about 3.0 mm.

16. The process of claim 13 wherein the decomposing comprises heating the composition within a reactor.

17. The process of claim 14 wherein the heating comprises applying a temperature of from about 150° C. to about 400° C. to the composition.

18. A fluorine-generation process comprising decomposing pellets of a fluorine-comprising material, wherein the pellets have an average size of from about 1.0 mm to about 3.0 mm.

19. The process of claim 18 wherein the fluorine-comprising material comprises A₂MF₆, the M being a transition metal and the A being an alkali metal.

20. The process of claim 19 wherein:
M is one or more of Mn, Fe, Co, Ni, and Cu; and
A is one or more of K and Cs.

21. The process of claim 18 wherein the fluorine-comprising material comprises one or more of K₂NiF₆, K₂CuF₆, CS₂CuF₆, Cs₂MnF₆, BiF₅, BiF₄, TiF₄, MnF₄, and K₃NiF₇.

22. The process of claim 18 wherein the fluorine-comprising material comprises one or more of Li, Cs, Mg, Ba, K, Bi, and Ti.
